(19) United States
(12) Patent Application Publication
(10) Pub. No.: US 2002/0174579 A1
(43) Pub. Date: Nov. 28, 2002

(54) Artificial log burning fireplace assembly

(76) Inventors: Arthur A. Corry, Naples, FL (US); Nigel Corry, Naples, FL (US); Wayne R. Newsome, Naples, FL (US)

Correspondence Address: MERRILL N. JOHNSON, 963 TRAIL TERRACE DRIVE, NAPLE, FL, 34103, US

(21) Appl. No.: 09/862,002

(22) Filed: May 22, 2001

(51) Int. Cl. G09F 19/00

(52) U.S. Cl. 40/428

(57) ABSTRACT

An artificial log burning fireplace assembly which produces a visual effect indistinguishable from a real log burning flame in a fireplace. The assembly includes one or more artificial logs lying horizontal along the front of the fireplace. A rod lies horizontally behind the artificial logs. A plurality of elongated pieces of colored fabric are spaced apart and one short end of each piece of colored fabric is attached to the rod. A pair of electrically powered blowers are positioned behind the artificial logs and each blower is mounted near one end of the rod. The blowers are angled one to the other to create in the region surrounding the pieces of colored fabric a turbulent air flow in the region surrounding the pieces of colored fabric thereby creating a visual effect that is indistinguishable from a real log burning flame in a fireplace.

### BACKGROUND OF THE INVENTION

Decorative electric fireplaces and assemblies to install in existing fireplaces have been manufactured and sold in Canada and the major countries of Europe for the past fifty years. In the United States interest in electric fireplaces has been negligible due largely to their artificial look compared to a real log burning fire or a gas fired artificial log fire.

At present five different types of decorative electric log fires are manufactured and sold worldwide:

1. A simulated transparent fiberglass log illuminated from an electric bulb and a spinner inside the log to create a blinking effect. There are no simulated flames.

2. Opaque transparent plastic plain or freznel screen used as a back projection screen when viewed from the front. The log display is set low and in front of the screen.

3. Flat microwave appearance with simulated log fire display inside the box. This gives a kind of hologram effect.

4. Regency or Victorian fire basket filled with pieces of colored glass that reflect light from an electric light bulb and spinner underneath the pieces of colored glass.

5. Log set with linear yellow and clear metal strips layered to resemble flame shapes with a blower underneath to simulate flames.

### SUMMARY OF THE INVENTION

We have invented an artificial log burning fireplace assembly which produces a visual effect indistinguishable from a real log burning flame in a fireplace. The visible effect is illuminated by a light bulb not visible to persons viewing the fireplace.

Our assembly includes one or more artificial logs lying horizontal across the front of the fireplace. A preferably metal rod lies horizontally behind the artificial logs. A number of elongated pieces of colored fabric are spaced apart and one short end of each piece of colored fabric is attached to the rod. A bed of artificial coals lies at the bottom of the fireplace and extends beneath the artificial logs and the elongated pieces of colored fabric attached to the rod.

A pair of electrically powered blowers are positioned behind the artificial logs and each blower is mounted near one end of the rod. The blowers are angled one to the other to create turbulent air flow in the region surrounding the pieces of colored fabric thereby creating a visual effect indistinguishable from a real log burning flame in a fireplace.

### DESCRIPTION OF THE DRAWING

FIG. 1 is a flow chart showing the interrelated steps required to practice our invention.

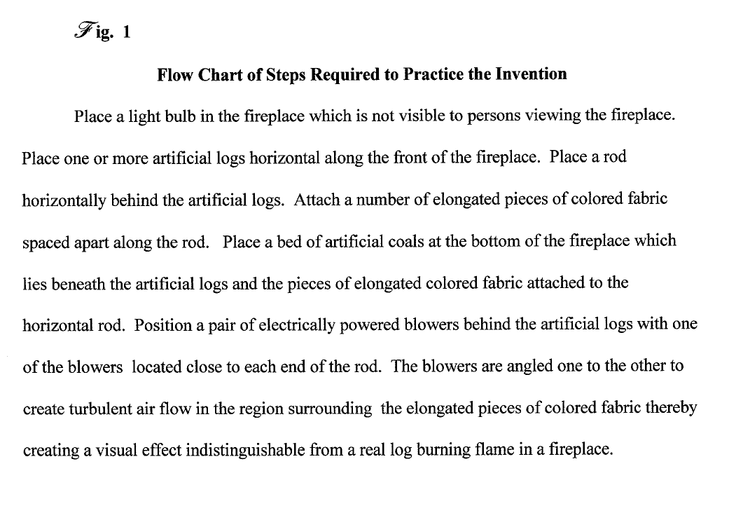

### DESCRIPTION OF THE PREFERRED EMBODIMENT

As related in the foregoing summary of our invention, we have invented an artificial log burning assembly which produces a visual effect indistinguishable from a real log burning flame in a fireplace.

But we have found that the very best visual effect is achieved when the elongated pieces of fabric spaced along the rod are all blue silk or nylon and the visual effect is viewed in an orange colored light created by having an orange colored shaped filter between the light source and the elongated pieces of silk or nylon.

By all of the elongated pieces of fabric being made of blue silk and viewed in an orange colored light, the orange light produces on the moving pieces of silk from time to time a change in their color from blue to yellow and then back to blue.

The blue flame color presents a hot non-carbon flame to the viewer, while the yellow flame color presents a cold high carbon content flame to the viewer. The visual effect is a fireplace with an artificial log fire whose simulated flames are perfect in both color and movement.

If the viewer desires the fireplace to give off heat, an electrically powered heater blower can be fitted beneath the visible log burning display.

While we have described and shown our invention and its preferred embodiment, the scope and breadth of our invention is defined only by the appended claims.

We claim:

1. Apparatus which creates a fireplace containing a simulated log fire comprising:
a light bulb not visible to persons viewing the fireplace;
at least one artificial log lying horizontally across the front of the fireplace;
a rod lying horizontally behind the one or more artificial logs;
a plurality of elongated pieces of colored fabric spaced apart and each having a short end attached to the rod;
a bed of artificial coals at the bottom of the fireplace extending beneath the artificial logs and the rods carrying the elongated pieces of colored fabric;
a pair of blowers positioned behind the artificial logs and each blower located close to one end of the rod;
the blowers being angled one to the other to create in the region surrounding the pieces of elongated colored fabric a turbulent air flow thereby creating a visual effect indistinguishable from the movement of a real log burning flame in a fireplace.

2. Apparatus as set forth in claim 1 including an electrically powered heater blower located beneath the visible log burning display.

3. Apparatus as set forth in claim 1 wherein the elongated pieces of fabric are all made of blue silk.

4. Apparatus as set forth in claim 1 wherein the elongated pieces of fabric are viewed in an orange colored light.
